(19) United States
(12) Patent Application Publication
(10) Pub. No.: US 2016/0180847 A1
(43) Pub. Date: Jun. 23, 2016

(54) MOBILE TERMINAL PHOTOGRAPHING CONTROL METHOD AND SYSTEM BASED ON SMART WEARABLE DEVICE

(71) Applicant: HUIZHOU TCL MOBILE COMMUNICATION CO.,LTD, Guangdong (CN)

(72) Inventors: Yan YANG, Huizhou, Guangdong (CN); Xiling CHEN, Huizhou, Guangdong (CN)

(73) Assignee: Huizhou TCL Mobile Communication Co., Ltd., Huizhou, Guangdong (CN)

(21) Appl. No.: 14/893,636

(22) PCT Filed: Sep. 5, 2014
(86) PCT No.: PCT/CN2014/085972

§ 371 Date: Nov. 24, 2015

(30) Foreign Application Priority Data
Jun. 23, 2014 (CN) 201410282116.9

(51) Int. Cl. G10L 15/22; G10L 15/30; H04N 5/44

(52) U.S. Cl. CPC G10L 15/22; H04N 5/44; G10L 15/30; G10L 2015/223; G10L 2015/225

(57) ABSTRACT

A mobile terminal photographing control method and system based on smart wearable devices is provided. The smart wearable device acquires and recognizes a voice command, and transmits the voice command to the mobile terminal. The mobile terminal receives the voice command and compares the voice command against a preset list including control commands corresponding to various photographing functions of the mobile terminal. When the command matching the voice command is found in the preset control commands list, the mobile terminal activates the corresponding photographing function and feeds back a match success command to the wearable device. The user doesn't have to manually switch the photographing functions of the mobile terminal, which brings huge convenience to the user.

### FIELD OF THE DISCLOSURE

The present disclosure relates to the field of mobile terminals, and in particular, to a mobile terminal photographing control method and system based on smart wearable devices.

### BACKGROUND OF THE DISCLOSURE

As communication technologies continue to evolve and mature, the software in mobile terminals is becoming more and more functional with the growing popularity of mobile terminals, and users are having more and more personalized demands. However, with the increasingly merger of mobile operation systems and hardware platforms, homogeneity of software functions is becoming more and more severe. Thus, constant innovation to bring in new personalized software features has become an imperative way to maintain the competitiveness of terminal products.

Currently, photographing functions in most mobile terminals are manually activated by the user according to particular needs, and cannot be automatically switched via remote control, for example, via gestures, which is very inconvenient for the user.

Therefore, the prior art has yet to be improved and developed.

### SUMMARY OF THE DISCLOSURE

The technical problem the present disclosure attempting to solve is, directing at the above mentioned deficiencies existing in the prior art, to provide a mobile terminal photographing control method and system based on smart wearable devices, which is designed to remedy the deficiencies in the prior art that photographing functions of the mobile terminal need to be manually switched by the user.

A technical solution adopted by the present disclosure in order to solve the technical problem is as following:

a mobile terminal photographing control method based on a smart wearable device according to the present disclosure, comprising:

receiving by the smart wearable device an operational command from the user, and in particular, acquiring and recognizing a voice command of the user, and transmitting the voice command to the mobile terminal;

receiving by the mobile terminal the voice command, and comparing the voice command against a preset control commands list corresponding to various photographing functions of the mobile terminal;

when the command matching the voice command is found in the control commands list, activating by the mobile terminal the corresponding photographing function, and feeding back a match success command to the smart wearable device; and

receiving by the smart wearable device the match success command, and prompting the user according to the match success command, wherein the smart wearable device prompts the user through vibration and a synchronous pop-up menu.

A mobile terminal photographing control method based on a smart wearable device according to the present disclosure, comprising:

receiving by the smart wearable device an operational command from the user, and in particular, acquiring and recognizing a voice command of the user, and transmitting the voice command to the mobile terminal;

receiving by the mobile terminal the voice command, and comparing the voice command against a preset control commands list corresponding to various photographing functions of the mobile terminal, when the command matching the voice command is found in the control commands list, activating by the mobile terminal the corresponding photographing function, and feeding back a match success command to the smart wearable device.

A mobile terminal photographing control system based on a smart wearable device according to the present disclosure, comprising:

a voice recognition and transmitting module, being configured to receive by the smart wearable device an operational command from the user, and in particular, acquire and recognize a voice command of the user and transmit the voice command to the mobile terminal;

a photographing function activation module, being arranged to receive by the mobile terminal the voice command, and compare the voice command against a preset control commands list corresponding to various photographing functions of the mobile terminal, when the command matching the voice command is found in the control commands list, activate by the mobile terminal the corresponding photographing function, and feed back a match success command to the smart wearable device.

In the mobile terminal photographing control method and system based on smart wearable devices provided by the present disclosure, the method comprises: receiving by the smart wearable device an operational command from the user, and in particular, acquiring and recognizing a voice command of the user, and transmitting the voice command to the mobile terminal; receiving by the mobile terminal the voice command, which is compared against a preset control commands list corresponding to various photographing functions of the mobile terminal, when the command matching the voice command is found in the control commands list, activating by the mobile terminal the corresponding photographing function, and feeding back a match success command to the smart wearable device. The smart wearable device in the present disclosure controls, according to the received voice command, the mobile terminal within a short distance switch among various photographing functions, thus eliminating the need for manual switching and bringing the user enormous convenience.

### BRIEF DESCRIPTION OF THE DRAWINGS

FIG. 1 is a flow chart diagram of a mobile terminal photographing control method based on a smart wearable device according to an exemplary embodiment of the present disclosure.

FIG. 2 is a block diagram of a mobile terminal photographing control system based on a smart wearable device according to an exemplary embodiment of the present disclosure.

### DETAILED DESCRIPTION OF THE DISCLOSURE

In order to make the purposes and technical solutions and advantages of the present disclosure clear and definite, a detailed description will be made on the present disclosure with reference to the accompanying drawings and cited embodiments. It should be appreciated that specific embodiments described herein are merely used to illustrate but not to limit the present disclosure.

In the following description, specific embodiments of the present disclosure will be described with reference to steps or symbols executed by one or more computers, unless otherwise stated. Therefore, these steps and operations will be mentioned more than once to be executed by computers. Computer execution referred to herein comprises operations performed by computer processing units, which represent electronic signals of the data within a structured type. These operations transform the data or maintain the data in the memory system of the computer, wherein the data can be reconfigured or otherwise change the functioning of the computer through means well known by one of ordinary skill in the art. The data structure maintained by the data is the physical location of the memory. The data structure comprises particular characteristics defined by the data format. Although the principles of the present disclosure are illustrated by the above text, it should not be construed as a limit to the present disclosure, and one of ordinary skill in the art will understand that the steps and operations described below can also be implemented by hardware.

The principles of the present disclosure may be performed by utilizing a number of other general-purposed or special-purposed operation environments, communication environments, or configurations. Examples of well known operation systems, operation environments and configurations applicable to the present disclosure can comprise, but are not limited to, hand-held phones, personal computers, servers, multi-processor systems, micro-computer based systems, main frame computers and distributed computing environments including any of the above mentioned systems or apparatuses.

The term “module” can be regarded as software objects executed on the computing system. The various components, modules, engines and services described herein can be regarded as objects implemented in the computing system. Apparatuses and methods described herein are preferably implemented in the form of software, and can without doubt be implemented by hardware, both falling within the scope of claim of the present disclosure.

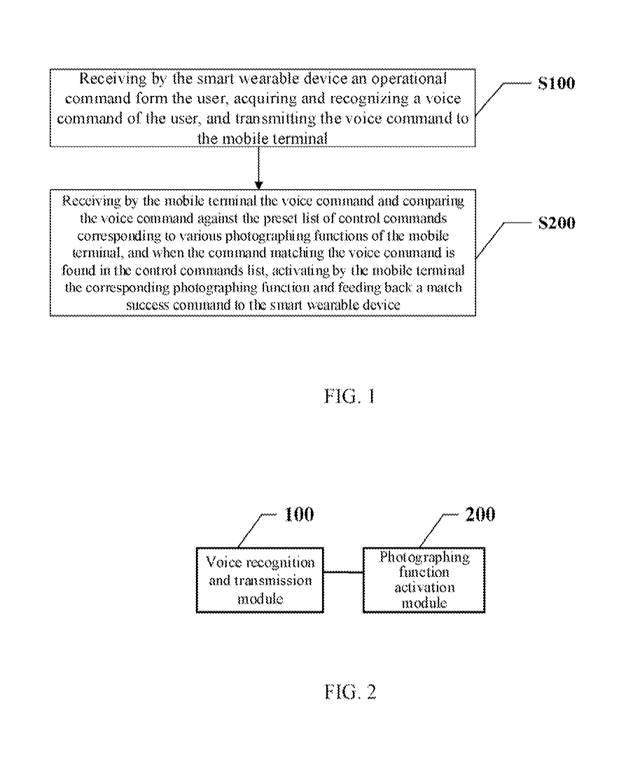

Referring to FIG. 1, which is a flow chart diagram of a mobile terminal photographing control method based on a smart wearable device according to an exemplary embodiment of the present disclosure. As is shown in FIG. 1, the mobile terminal photographing control method based on a smart wearable device comprises the following steps:

Step S100: Receiving by the smart wearable device an operational command from the user, and in particular, acquiring and recognizing a voice command of the user and transmitting the voice command to the mobile terminal.

In an exemplary embodiment according to the present disclosure, when the user desires to activate one of various photographing functions in the mobile terminal, the user may enable the voice recognition function of the smart wearable device, and may render any voice commands to the smart wearable device. The smart wearable device acquires and recognizes the voice command from the user, and transmits the voice command to the mobile terminal. It should be noted that, in the step S100, the mobile terminal doesn't directly acquire the voice command from the user, but indirectly acquire the voice command of the user via the smart wearable device, thus a problem that the mobile terminal cannot distinctly recognize the voice command because it is relatively far away from the user and thus resulting in the failure of voice acquisition is avoided.

Step S200: Receiving by the mobile terminal the voice command, and comparing the voice command against a preset control commands list corresponding to various photographing functions of the mobile terminal, when the command matching the voice command is found in the control commands list, activating by the mobile terminal the corresponding photographing function, and feeding back a match success command to the smart wearable device.

In the step S200, when the mobile terminal receives the voice command, the voice command is compared against the preset control commands list corresponding to various photographing functions of the mobile terminal. When the command matching the voice command is found in the control commands list, the mobile terminal activates the corresponding photographing function, and feeds back the match success command to the smart wearable device. Certainly, if the match fails, the mobile terminal may also send a feedback message to the smart wearable device, prompting the user whether the mobile terminal has activated the corresponding photographing function successfully or not.

In addition, the embodiment further comprises, before the step S100 where the smart wearable device acquires the voice command:

S10: Presetting a control commands list corresponding to various photographing functions of the mobile terminal.

Specifically, for example, the control commands list can be set as Table 1 which is shown below:

TABLE 1

| Voice commands | Functions |
|---|---|
| taking a photo | The terminal takes a photo according |
| | to current device mode |
| Parameter-modifying | The terminal enters the parameter- |
| photographing mode | modifying photographing mode |
| Selecting Panorama mode | The terminal selects the panorama |
| | mode to photograph |
| Other user-defined commands | The terminal receives and stores the |
| | user-defined voice commands. |

The contents in Table 1 are for illustration only. The commands that can be stored by the mobile terminal may include but are not limited to the above commands. These voice commands have attributes of being addable, editable and deletable.

In a further embodiment, the step S200 also comprises: prompting the smart wearable device the user through vibration and a synchronous pop-up menu.

In addition, this embodiment further comprises, after the step S200 where a photographing function is activated:

S300: When the command matching the voice command is not found in the control commands list, feeding back by the mobile terminal a match failure command to the smart wearable device; the smart wearable device receiving the match failure command, and prompting the user according to the match failure command.

In particular, when the smart wearable device receives the match success command, then it is determined whether the prompting mode of the smart wearable device is vibration. When the prompting mode of the smart wearable device is determined to be vibration, then the smart wearable device prompts the user by vibration, and the user may check the pop-up menu on the smart wearable device after he/she perceives the vibration alert. He/she may begin to take photos after checking the match success message. When the prompting mode of the smart wearable device is determined not to be vibration, then the wearable device prompts the user to check the pop-up menu by a buzzing sound.

As can be seen, no matter whether the voice command are matched successfully or not, the smart wearable device will generally prompt the user to check the pop-up menu through vibration or a buzzing sound, so as to enable the user to timely acquire the information whether the corresponding photographing function has been activated or not, which facilitates the user to perform the next operation.

Further, the step S100 where the smart wearable device acquires the voice command further comprises:

Step S101: Receiving by the smart wearable device an operational command from the user, and acquiring and recognizing a voice command of the user.

Step S102: Converting by the smart wearable device the voice command to digital voice information by analog-to-digital conversion.

In the step S102, an ADC (analog-to-digital converter) in the smart wearable device converts the voice command into digital signals, which are further processed by DSP (digital signal processing) into pure PCM (pulse-code modulation) data, i.e., digital voice information.

Step S103: Transmitting by the smart wearable device the digital voice information to the mobile terminal.

In addition, the step S200 of activating the photographing function further comprises:

Step S201: Receiving by the mobile terminal the digital voice information.

Step S202: Comparing the digital voice information against a preset control commands list corresponding to various photographing functions of the mobile terminal.

In the preset control commands list in step S10, all the commands are found in the form of digital voice information, i.e., in the form of pure PCM data. Therefore, the comparison between the digital voice information and the preset control commands list is the comparison between PCM data.

Step S203: When the command matching the digital voice information is found in the control commands list, activating by the mobile terminal the corresponding photographing function, and feeding back a match success command to the smart wearable device.

Below a specific application example will be utilized to further explain the technical solution according to the present disclosure.

Providing the mobile terminal is 2 meters apart from the user, when the user renders to the smart wearable device a voice command of “selecting panorama mode”, the smart wearable device receives the voice command and converts the voice command into digital voice information, which is further sent to the mobile terminal. The mobile terminal receives the digital voice information and compares the digital voice information against a preset control commands list corresponding to various photographing functions of the mobile terminal. When the command matching the digital voice information of “selecting Panorama mode” is found in the control commands list, the mobile terminal selects the Panorama mode and takes photos accordingly, and simultaneously feeds back a match success command to the smart wearable device. The smart wearable device receives the match success command and prompts the user via vibration. The user checks the pop-up menu displayed on the display of the smart wearable device, knowing the match is successful and preparing to take photos.

As can be seen from above, the smart wearable device remotely controls the mobile terminal activate corresponding photographing functions, thus, the role of the smart wearable device is similar to a remote controller. By the above mentioned remote voice control, the user can take a photograph of himself/herself without others' help, providing enormous convenience to the user.

Base on the aforementioned embodiments, the present disclosure further provides a mobile terminal photographing control system based on a smart wearable device. The mobile terminal photographing control system comprises, as is shown in FIG. 2:

a voice recognition and transmitting module 100, being configured to receive by the smart wearable device an operational command from the user and acquire and recognize a voice command of the user, and transmit the voice command to the mobile terminal; for detailed description, please see above;

a photographing function activation module 200, being arranged to receive by the mobile terminal the voice command, and compare the voice command against a preset control commands list corresponding to various photographing functions of the mobile terminal. When the command matching the voice command is found in the control commands list, the mobile terminal activates the corresponding photographing function, and feeds back a match success command to the smart wearable device; for detailed description, please see above.

In addition, the mobile terminal photographing control system based on a smart wearable device further comprises:

an error prompting module 300, being configured to, when the command matching the voice command is not found in the control commands list, feed back by the mobile terminal a match failure command to the smart wearable device; the smart wearable device receives the match failure command, and prompts the user according to the match failure command.

Additionally, the voice recognition and transmitting module 100 further comprises:

a voice acquisition and recognition module 101, being configured to receive by the smart wearable device an operational command from the user, and in particular, acquire and recognize a voice command of the user; for detailed description, please see above;

a code modulation unit 102, being configured to convert by the smart wearable device the voice command to digital voice information by analog-to-digital conversion; for detailed description, please see above;

a transmitting unit 103, being configured to transmit by the smart wearable device the digital voice information to the mobile terminal; for detailed description, please see above.

In addition, the photographing function activation module 200 specifically comprises:

a receiving unit 201, being configured to receive by the mobile terminal the digital voice information; for detailed description, please see above;

a comparing unit 202, being configured to compare the digital voice information against a preset control commands list corresponding to various photographing functions of the mobile terminal; for detailed description, please see above;

a photographing function activation unit 203, being configured to, when the command matching the digital voice information is found in the control commands list, activate by the mobile terminal the corresponding photographing function, and feed back a match success command to the smart wearable device; for detailed description, please see above;

In summary, the present disclosure provides a mobile terminal photographing control method and system based on smart wearable devices, the method comprising: receiving by the smart wearable device an operational command from the user, and in particular, acquiring and recognizing a voice command of the user, and transmitting the voice command to the mobile terminal; receiving by the mobile terminal the voice command, which is compared against a preset control commands list corresponding to various photographing functions of the mobile terminal, when the command matching the voice command is found in the control commands list, activating by the mobile terminal the corresponding photographing function, and feeding back a match success command to the smart wearable device. The smart wearable device in the present disclosure controls, according to the received voice command, the mobile terminal within a short distance switch among various photographing functions, thus eliminating the need for manual switching and bringing huge convenience to the user.

It should be appreciated that the application of the present disclosure should not be limited to the above examples, which can be further improved or transformed by one of ordinary skill in the art according to the above description. Any improvements or transformations should all be covered within the scope of appended claims of the present disclosure.

1. A mobile terminal photographing control method based on a smart wearable device, comprising:
receiving by the smart wearable device an operational command from a user, acquiring and recognizing a voice command of the user, and transmitting the voice command to the mobile terminal;
receiving by the mobile terminal the voice command and comparing the voice command against a preset control commands list corresponding to a plurality of photographing functions of the mobile terminal;
when the command matching the voice command is found in the control commands list, activating by the mobile terminal the corresponding photographing function, and feeding back a match success command to the smart wearable device; and
receiving by the smart wearable device the match success command, and prompting the user according to the match success command, wherein the smart wearable device prompts the user via vibration and a synchronous pop-up menu.

2. (canceled)

3. The mobile terminal photographing control method based on a smart wearable device according to claim 1, wherein the step of receiving by the smart wearable device the operational command from the user, acquiring and recognizing the voice command of the user, and transmitting the voice command to the mobile terminal, comprising:
receiving by the smart wearable device the operational command from the user, acquiring and recognizing the voice command of the user;
converting by the smart wearable device the voice command to digital voice information by analog-to-digital conversion; and
transmitting by the smart wearable device the digital voice information to the mobile terminal.

4. The mobile terminal photographing control method according to claim 3, wherein the step of receiving by the mobile terminal the voice command and comparing the voice command against the preset control commands list corresponding to the plurality of photographing functions of the mobile terminal, comprising:
receiving by the mobile terminal the digital voice information;
comparing by the mobile terminal the digital voice information against the preset control commands list corresponding to the plurality of photographing functions of the mobile terminal.

5. The mobile terminal photographing control method based on a smart wearable device according to claim 4, wherein the step of when the command matching the voice command is found in the control commands list, activating by the mobile terminal the corresponding photographing function, and feeding back the match success command to the smart wearable device, comprising:
when the command matching the digital voice information is found in the control commands list, activating by the mobile terminal the corresponding photographing function of the mobile terminal, and feeding back the match success command to the smart wearable device.

6. (canceled)

7. A mobile terminal photographing control method based on a smart wearable device, comprising:
receiving by the smart wearable device an operational command from a user, acquiring and recognizing a voice command of the user, and transmitting the voice command to the mobile terminal;
receiving by the mobile terminal the voice command, and comparing the voice command against a preset control commands list corresponding to a plurality of photographing functions of the mobile terminal, when the command matching the voice command is found in the control commands list, activating by the mobile terminal the corresponding photographing function, and feeding back a match success command to the smart wearable device.

8. The mobile terminal photographing control method based on a smart wearable device according to claim 7, further comprising, after the step of feeding back the match success command to the smart wearable device:
receiving by the smart wearable device the match success command and prompting the user according to the match success command.

9. The mobile terminal photographing control method according to claim 7, further comprising, after the step of receiving by the mobile terminal the voice command and comparing the voice command against the preset control commands list corresponding to the plurality of photographing functions of the mobile terminal:
when the command matching the voice command is not found in the control commands list, feeding by the mobile terminal a match failure command back to the smart wearable device; and
receiving by the smart wearable device the match failure command and prompting the user according to the match failure command.

10. The mobile terminal photographing control method based on a smart wearable device according to claim 7, wherein the step of receiving by the smart wearable device the operational command from the user, acquiring and recognizing the voice command of the user, and transmitting the voice command to the mobile terminal, comprising:
receiving by the smart wearable device the operational command from the user, acquiring and recognizing the voice command of the user;
converting by the smart wearable device the voice command to digital voice information by analog-to-digital conversion; and
transmitting by the smart wearable device the digital voice information to the mobile terminal.

11. The mobile terminal photographing control method based on a smart wearable device according to claim 10, wherein the step of receiving by the mobile terminal the voice command and comparing the voice command against the preset control commands list corresponding to the plurality of photographing functions of the mobile terminal, and when the command matching the voice command is found in the control commands list, activating by the mobile terminal the corresponding photographing function, and feeding back the match success command to the smart wearable device, comprising:
receiving by the mobile terminal the digital voice information;
comparing the digital voice information against the preset control commands list corresponding to the plurality of photographing functions of the mobile terminal;
when the command matching the digital voice information is found in the control commands list, activating the corresponding photographing function of the mobile terminal, and feeding back the match success command to the smart wearable device.

12-13. (canceled)

14. A mobile terminal photographing control system based on a smart wearable device, comprising:
a processor; and
a non-transitory program storage medium, comprising:
a voice recognition and transmitting module, being configured to receive by the smart wearable device an operational command from a user, acquire and recognize a voice command of the user, and transmit the voice command to the mobile terminal;
a photographing function activation module, being arranged to receive by the mobile terminal the voice command, and compare the voice command against a preset control commands list corresponding to a plurality of photographing functions of the mobile terminal, when the command matching the voice command is found in the control commands list, activate by the mobile terminal the corresponding photographing function, and feed back a match success command to the smart wearable device.

15. The mobile terminal photographing control system based on a smart wearable device according to claim 14, further comprising:
an error prompting module, being configured to, when the command matching the voice command is not found in the control commands list, feed back by the mobile terminal a match failure command to the smart wearable device; the smart wearable device receives the match failure command, and prompts the user according to the match failure command.

16. The mobile terminal photographing control system based on a smart wearable device according to claim 14, wherein the voice recognition and transmitting module comprises:
a voice acquisition and recognition unit, being configured to receive by the smart wearable device an operational command from the user, acquire and recognize a voice command of the user;
a code modulation unit, being configured to convert by the smart wearable device the voice command to digital voice information through analog-to-digital conversion;
a transmitting unit, being configured to transmit by the smart wearable device the digital voice information to the mobile terminal.

17. The mobile terminal photographing control system based on a smart wearable device according to claim 16, wherein the photographing function activation module comprises:
a receiving unit, being configured to receive by the mobile terminal the digital voice information;
a comparing unit, being configured to compare the digital voice information against the preset control commands list corresponding to the plurality of photographing functions of the mobile terminal;
a photographing function activation unit, being configured to, when the command matching the digital voice information is found in the control commands list, activate by the mobile terminal the corresponding photographing feature, and feed back a match success command to the smart wearable device.

18. The mobile terminal photographing control method based on a smart wearable device according to claim 1, further comprising, after the step of receiving by the mobile terminal the voice command and comparing the voice command to the preset list of control commands corresponding to the plurality of photographing features of the mobile terminal:
when the command matching the voice command is not found in the control commands list, feeding by the mobile terminal a match failure command back to the smart wearable device; and
receiving by the smart wearable device the match failure command and prompting the user according to the match failure command.

19. The mobile terminal photographing control method based on a smart wearable device according to claim 18, wherein the step of receiving by the smart wearable device the match failure command and prompting the user according to the match failure command comprises:
receiving by the smart wearable device the match failure command, and prompting the user according to the match failure command by vibration and a pop-up menu.

20. The mobile terminal photographing control method based on a smart wearable device according to claim 8, wherein the step of receiving by the smart wearable device the match success command and prompting the user according to the match success command comprises:
receiving by the smart wearable device the match success command, and prompting the user according to the match success command by vibration and a pop-up menu.

21. The mobile terminal photographing control method based on a smart wearable device according to claim 9, wherein the step of receiving by the smart wearable device the match failure command and prompting the user according to the match failure command comprises:
receiving by the smart wearable device the match failure command, and prompting the user according to the match failure command by vibration and a pop-up menu.
